(19) United States
(12) Patent Application Publication
(10) Pub. No.: US 2022/0364944 A1
(43) Pub. Date: Nov. 17, 2022

(54) External-Mounted Strain Sensor System for Non-Invasive Measurement of Internal Static and Dynamic Pressures in Elastic Bodies

(71) Applicants: Christopher Robert Fuller, Virginia Beach, VA (US); Curtis R. Mitchell, Gainesville, VA (US); OFMS, LLC, Blacksburg, VA (US)

(72) Inventors: Christopher Robert Fuller, Virginia Beach, VA (US); Curtis R. Mitchell, Gainesville, VA (US)

(21) Appl. No.: 17/754,598

(22) PCT Filed: Oct. 6, 2020
(86) PCT No.: PCT/US2020/054437

§ 371 Date: Apr. 6, 2022

Related U.S. Application Data
(60) Provisional application No. 62/911,370, filed on Oct. 6, 2019.

(51) Int. Cl. G01L 17/00; G01L 1/16; G01L 1/20; G01L 1/22; G01L 19/08

(52) U.S. Cl. CPC G01L 17/005; G01L 1/16; G01L 1/205; G01L 1/2218; G01L 19/086

(57) ABSTRACT

A sensor system comprises flexible piezoelectric polyvinylidene fluoride wire/strip and/or a short/extended strain gauge wire/printed strain gauge transducers to measure both static and dynamic pressure, conditioning electronics, installation/adherence tool, calibration tool, electronic devices for measuring pressure outputs, and wireless transmission of sensor signal through a data acquisition system to a smart device. A software application for reading the output of the strain gauges remotely is included. Individual system components include distributed strain sensors, custom printed strain gauges, strain gauge wires, calibration rig, slotted ring clamp, strain measuring devices, and software application for visualization of pressure readings.

### RELATED APPLICATIONS

This application claims the benefit of U.S. Provisional Application Ser. No. 62/911,370 entitled “EXTERNAL-MOUNTED STRAIN SENSOR SYSTEM FOR NON-INVASIVE MEASUREMENT OF INTERNAL STATIC AND DYNAMIC PRESSURES IN ELASTIC BODIES” filed on 6 Oct. 2019, the contents of which are incorporated herein by reference in its entirety.

### COPYRIGHT NOTICE

A portion of the disclosure of this patent document may contain material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

Measuring fluid-borne acoustic signatures has been a field of practice utilized in many fields and disciplines. Aerospace (rockets and related vehicles), ocean or freshwater going vessels (submarines, boats, ships), gas/oil distribution pipelines, animal and human tubular structures, and the like rely on successful measurement of pressures and strains of the mechanics utilized in fluid transport. Essentially any location, facility or mechanical device, which transports fluids through equipment, utilizes such technology. Additionally, living organisms such as human and domestic animals also conduct fluid and gas distribution, including hemoglobin, cerebrospinal fluid, breathing, and the like.

A need for measuring fluid acoustics and strains on related equipment has become more clearly identified, particularly in a method that does not require modification or penetration of existing structures that carries the fluid. Although there are several methods of measurement of acoustic signatures, the current prevalent method is for modification to existing structures such as drilling holes for insertion of acoustic and pressure measuring devices.

Another drawback is that current methods require significant cost, skill, and precision to attach invasive measuring tools. These methods therefore increase expense and maintenance of the measurement system, require costly replacement due to age, and potentially compromise the integrity of the system in which invasive measurement was introduced. Thus, a real need exists for a non-invasive externally mounted strain sensor system that is capable of measuring and recording the static/dynamic outputs of fluid-borne acoustic and the pressure signatures contained in elastic structures. A further need exists in ease of installation of measuring devices due to space limitations, such as space between a pipe and other pipes or rigid structure, other obstructions, or whether an installer is left or righthanded.

A further need exists for a measurement system that can accommodate different pipe or elastic body sizes, shapes, and material properties for the structure carrying the fluid. Examples include pipes with varying modulus properties, oblong animal and human organ/bone shapes and density including brain, veins, respiratory system/chest cavity. Furthermore, there is also a need for the measurement system to be configured and calibrated through combinations of analytical, empirical, and testing procedures.

Yet a further need is to process the signals from an array of sensors (100)/(400) of the measurement systems in order to measure variables such as acoustic wave speed, made out on frequencies and associated variables such as wall thickness, corrosion, slug flow, constriction, bearing faults, bubble streams, and the like.

### SUMMARY OF THE INVENTION

The present invention is an externally-mounted strain sensor (100)/(400) system (12) and an array of sensors (100)/(400) in externally-mounted strain sensor (100)/(400) systems (12). This system includes sensors, having either a flexible piezoelectric polyvinylidene fluoride (PVDF) wire/strip (101) wrapped around elastic pressure vessel (r) walls to measure internal fluid-borne acoustic signatures to measure dynamic pressure and/or a short/extended strain gauge wire/printed strain gauge transducers (401) to measure static pressure.

Applications of the sensor includes, but are not limited to, measuring internal fluid, gas, or other material dynamic/static pressures present in an elastic container of fluid containing either liquid or gaseous state. The elastic containers measured may include, but are not limited to, those composed of iron, steel, polyvinyl chloride (PVC), or other material pipes (regardless of diameter or length run). Examples of elastic containers measured may include submarine hulls, fluid tanks such as gas and oil tanks, pipelines including oil, gas and water, and the like. Additional examples include measurements of pressures in chest for measurement of breathing, blood pressure in veins and arteries, blood pressure in the brain, and other areas of pressure in human or animal bodies.

The sensor system (12) further includes sensors (100)/(400) and signal conditioning electronics (600), installation and mounting tool and clamp (200), calibration tool, and cloud software application, that when combined collectively from a sensor or an array of sensors (100)/(400), measure and analyze static and dynamic outputs of internal pressures within elastic bodies as well as other parameters such as flow rate, corrosion of the containing body, bubble in the fluid media and non-homogeneity of the fluid. The dynamic output is scalable to the fluid sound pressure level to improve monitoring and controlling unwanted acoustic signatures.

An advantage of this invention differs from other sensor systems in that it is non-intrusive to the elastic body, element or material, such as plastic or metal pipes, pressure vessels, animal body parts, human body parts, and the like, requiring no penetration in the material to measure the internal pressure of the fluid medium. All elastic bodies herein that are measured are referred to as “surface of the elastic pressure vessel (r) or the like. A cloud-based data collection and storage infrastructure is included with predictive signal analysis, modeling analytics, alerts/notifications, and full visualization support through a mobile application supported across all client platforms.

Another advantage of the present invention is that is senses overall or integral expansion, otherwise known as a “hoop strain”, and not the local effects of the increase in pressure. This is achieved by wrapping the strain sensor (100)/(400) a complete number of turns around the elastic body. The present invention solves the identified problems of sensor technologies associated with installation difficulties, space limitations, and avoids direct penetration of structures (e.g. drilling holes in pipes, cranium) to measure the pressure.

An aspect of the present invention is a sensor system (or array of sensors systems) (100)/(400) comprising a new, unique, and novel non-invasive system for measuring fluid-borne acoustic signatures in both static and dynamic forms that is capable of being installed on various pipes, or other varied devices and bodies, where measurement of strain and/or pressures is needed.

Another aspect of the present invention includes measuring internal fluid static or dynamic pressure of any elastic container of fluid without damaging the elastic container by drilling, piercing, or otherwise breaching the surface thereof. Such elastic containers include, but are not limited to, piping systems, boilers, submarine hulls, fluid tanks, long haul oil and gas pipelines, residential sewage egress, water supply, or any other type of vessel (r) with a fluid under pressure. Furthermore, human and animal parts such as the cranium, limbs, chest, or other parts where pressure occurs, can be measured. In addition, an array of sensors (100)/(400) can be used to measure fluid flow rate, corrosion of the elastic container, bubbles in the fluid and inhomogeneity of the fluid. However, additional applications where measurement of strain and/or pressure is needed beyond these examples is highly likely.

Another aspect of the invention is that the system is comprised of distributed strain sensors (100)/(400) either single or in an array (100)/(400), custom printed strain gauges (401), calibration rig (500), slotted ring clamps (200) (which are configured to maintain proximity of the strain gauges (401) to the device being measured and serve as an installation tool of the sensor (100)/(400) itself), sensor power/conditioning module (600), and software applications.

Further objects, features, advantages, properties, and other aspects of the system according to the present application will become apparent from the detailed description of the following drawings and specification.

### BRIEF DESCRIPTION OF THE DRAWINGS

The novel features of the described embodiments are specifically set forth in the appended claims; however, example embodiments relating to the structure of the present invention, may best be understood with reference to the following description and accompanying drawings.

FIG. 1 shows an isometric view of a PVDF wire (101) utilized in various alternative embodiments of the present invention.

FIG. 2 is a perspective view showing a printed sensor clamp (200) for the PVDF wire/strip (101) with a sensor electronics access cover off according to an embodiment of the present invention including the groove (211) in which the sensor resides.

FIG. 3 shows the embodiment of a printed clamp (200) as shown in FIG. 2 with the sensor electronics access cover in place and a connector for a PVDF wire (101) in place and clamp (200) secured with a bolt.

FIG. 4 is a plan view of the printed strain gauge utilized in an alternative sensor of the present invention.

FIG. 5 is a perspective view of a calibration rig (500) with a sensor clamp (200) attached thereto according to an embodiment of the present invention.

FIGS. 6A and 6B are plan views of PVDF wire/strip (101) power and control modules used with alternative embodiments of the present design.

FIG. 7 is a schematic view of a power control module control circuit board (601) utilized in the various embodiments of the present invention.

FIG. 8 is an example table reflecting the nominal sensitivity of PVDF sensors on standard schedule 40 Steel pipe sizes, based on number of turns (1-4) of the sensor wire (101)/(401) per nominal pipe diameter (inches).

FIG. 9 is an example table reflecting the nominal sensitivity of PVDF sensors on standard schedule 80 Steel pipe sizes, based on number of turns (1-4) of the sensor wire (101)/(401) per nominal pipe diameter (inches).

FIG. 10 is an example table reflecting the nominal sensitivity of PVDF sensors on standard schedule 120 Steel pipe sizes, based on number of turns (1-4) of the sensor wire (101)/(401) per nominal pipe diameter (inches).

FIG. 11 is an example table reflecting the nominal sensitivity of PVDF sensors on standard schedule 160 Steel pipe sizes, based on number of turns (1-4) of the sensor wire (101)/(401) per nominal pipe diameter (inches).

FIG. 12 is an object diagram reflecting the software application data flows according to alternative embodiments of the present invention.

FIG. 13 is an object diagram of the interconnect elements of the software application according to alternative embodiments of the present invention.

FIG. 14 is a table showing the methods and operations of the software application according to alternative exemplary embodiments of the present invention.

FIG. 15 is a view of the application start screen according to an embodiment of the present design.

FIG. 16 is a view of the software application showing retrieved data mapped in x and y axis according to an embodiment of the present design.

FIG. 17 is a schematic view demonstrating a sensor attached to a human head for pressure readings.

FIG. 18 is a schematic view of a PVDF sensor attached to a human chest for pressure readings.

FIG. 19 is a schematic view of a PVDF sensor array (100)/(400) attached to a pipeline, such as an oil pipeline of an oil well, to monitor the health of the pipeline.

FIG. 20 is an object diagram reflecting a monitoring of the software data flow.

Similar reference characters denote corresponding features consistently throughout the attached drawings.

### DETAILED DESCRIPTION OF PREFERRED EMBODIMENTS

The present invention is drawn to an externally mounted strain sensor (100)/(400) system (12) and to an array of sensors (100)/(400) composed of a plurality of individual strain sensor (100)/(400) systems (12). This system (12) is based on a flexible piezoelectric polyvinylidene fluoride (PVDF) wire (101) or strip transducer and includes a printed strain gage transducer (401) or a resistor wire (101)/(401) wrapped around a container with elastic pressure vessel (r) walls to measure internal fluid borne acoustic signatures.

The system (12) includes two sensor types (100)/(400), controlling electronics (600), installation/adherence tool (200), calibration rig (500), measuring devices, wireless transmission of sensor signal through a data acquisition system, and software application for smart phones and or tablets for visualization of recorded data to produce either a static or dynamic output depending on the type of transducer used. Software for processing the sensor(s) output to measure dynamic pressure, static pressure, flow rate, corrosion of elastic body, bubbles in the fluid, slug flow, pump and bearing faults, and in homogeneity of the fluid is also included. The specific system components include a PVDF distributed strain sensor (100)/(400) (100) transducer, custom printed strain gauge transducer, calibration rig (500), slotted ring clamp (200) for PVDF sensor, PVDF sensor power/conditioning (600), sensor output recording module, software for processing the strain signals, and a software application for visualization of measurements recorded from the sensors. The term “each” as used herein shall refer to every one of one or more sensors, and not just every one of two or more sensors as the term is conventionally defined.

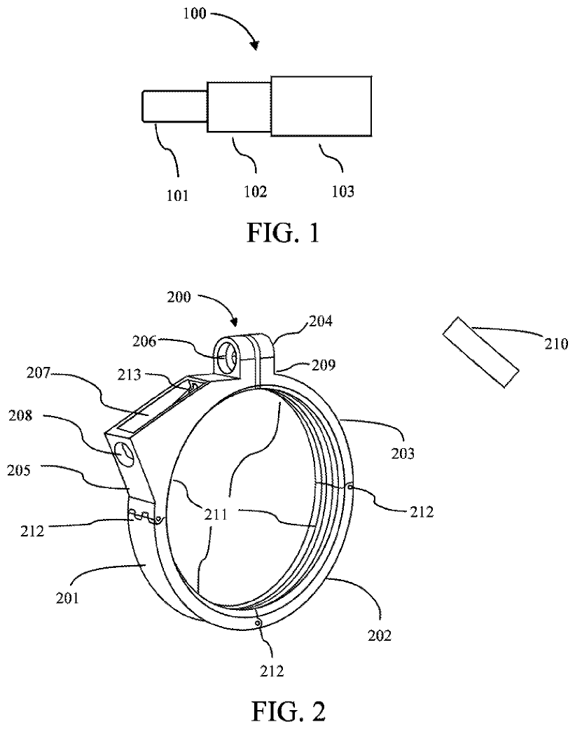

FIG. 1 shows the distributed strain sensor (100)/(400) (100) in a shielded sensor assembly constructed with standard, grey PVC-coated shielded 20 AWG wire material (101). Ruggedization is achieved by painting an adhesive shielding electrode (conductive) material directly on the sensor (102) followed by the addition of Raychem Versafit V4 material (103), which is an extremely low temperature heat shrink tubing. An alternative ruggedized sensor (100) with increased sensitivity can also be created with the same configuration. This ruggedization is achieved through a robust shielded coaxial cable (RG-58 cable with an additional braided shield and outer jacket) as a lead configuration to maintain triaxial geometry end-to-end. A system for grounding and shielding the sensor to reduce/eliminate electro-magnetic and background noise may also be incorporated.

FIG. 2 is an embodiment of a slotted ring clamp (200). The clamp (200) is used for both installation and non-permanent attachment of a distributed strain sensor (100)/(400) (100) to the pipe/vessel (r) being measured. The ring clamp (200) is a four-section configuration manufactured using traditional 3D metal and/or Carbon Fiber, Kevlar or other reinforced composite plastic 3-7 D printing techniques or other methods. Each of the four sections (201), (202), (203) and (205) provides for 25% of the circumference of the pipe being measured. Two sections (201) and (202) are similar in function as they have hinges (212) for attachment to the other sections of the clamp (200) and have helical groove (211) on the interior edge of the parts. A third part of the clamp (203) includes a hole (204) for a spring-loaded screw at (300) to be inserted in addition to a hinge connection point (212) and helical groove (211). The fourth main portion of the clamp (205) includes a hole (206) for that matches to the spring screw hole (204) in the third part of the clamp (203) to complete the spring-loaded screw installation. The fourth part of the clamp (205) also includes a compartment (207) for sensor access and sensor termination as well as a hole (208) for sensor termination. Other compression/securing devices such as a latch can be used.

A hole (213) is included in the fourth clamp part (205) to feed the PVDF wire (101) into the clamp (200). A cover (210) is put in place over the sensor termination/electronics compartment (207) on the fourth clamp part (205) for sealing the compartment after sensor wire (101) installation in the clamp (200). The clamp parts (201), (202), (203) and (205) include helical grooves (211) which, when all four parts (201), (202), (203) and (205) of the clamp (200) are assembled, serve as a continuous groove (211) for PVDF wire (101) installation in a self-winding manner as the wire (101) is fed into the installation access hole (213).

Fastening of the clamp (200) to a pipe is achieved using a spring-loaded screw or latch which is placed through the corresponding screw hole (204) on the third part of the clamp (203) and screw hole (206) of the fourth part (205) of the clamp (200). All four parts of the clamp (201), (202), (203) and (205) are grooved (211) in a helical manner to facilitate the self-winding function of the clamp (200). In addition to the use of the spring-loaded screw/latch or the like for fastening, the clamp parts (201), (202), (203) and (205) are fastened together using pins at hinge points (212) located on each part of the clamp parts (201), (202), (203) and (205).

Installation of the wire sensors (101) is achieved through pushing the triaxial cable end of the sensor into the self-winding clamp (200) via the feed hole (213) on the fourth main clamp part (205) at compartment (207). The self-winding around the pipe (or other element being measured) is achieved through the grooves (211) in the assembled clamp (200) that serve as threads for the wire (101) to be wound through until completely wound in the clamp (200). These concentric grooves (211) prohibit the wire (101) from winding over itself and ensure complete turns of the wire occur. Upon successful feeding of the wire (101) fully into the clamp (200) from feed end and through the internal groove (211), the wire (101) feeds out the opposite side of the third clamp part (203) part via an exit port (209) on the third part of the clamp (203). Through the consistent tension of clamp (200) installation and self-winding of the sensor (100), consistent installation is achieved and linear stress (stretching) of the sensor (100) is avoided. Avoidance of linear stress ensures consistent sensor readings. Other variations of the clamp (200) have grooves (211) so that partial turns of the PVDF wire (101) can occur.

Termination of the PVDF wire/strip (101) sensor (100) at the vessel/pipe (r) being measured is achieved using a threaded compression nut at (300) that attaches to connector (301) such as an MCX connector (301) or a latch located in the sensor access compartment/termination box at (208) on the clamp (200). The compression nut is tightened at the end of threading the sensor (100) into the self-winding clamp (200). The end opposite of the termination end of the PVDF sensor (100) end is connected via an MCX connector (301) to the systems conditioning/power module (600). The distributed strain sensor (100)/(400) (100) is utilized to achieve dynamic pressure output.

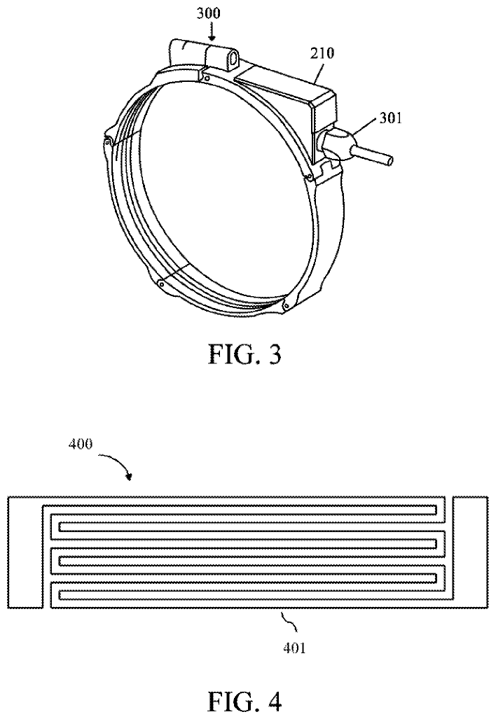

Commodity coaxial cable ends are utilized for integration into the clamp (200). A connector (301), such as an “MCX-style” connector (301), is used as the interconnect between the sensor wire (101) and the triaxial cable. While there is potential for unshielded cable length with this configuration, the length is to be kept as short as possible, and only be exposed from within the termination box (301) of the design clamps (200). FIG. 3 reflects the MCX style coaxial connectors (301) used to mate the PVDF sensor wire (101) with the triaxial shielded lead attached to the ring clamp (200).

FIG. 4 is an embodiment of the custom printed strain gauges (400). These gauges (400) are of arbitrary size, manufactured on demand using an inkjet printer specially retrofitted to deposit ink made conductive by the addition of silver particles. The silver conductive ink is jetted onto surface treated PET sheets (401) for adherence of the ink to the sheet (401). Installation of the custom printed strain gauge (400) is completed utilizing a semipermanent adhesive (glue). In this embodiment, the sensor (100) is glued directly to the elastic vessel (r) for which sensing is needed, with multiple gauges (400) installed as needed. The custom printed strain gauges (400) are utilized to capture static pressure output and are of extended length to be able to completely wrap around the pipe or elastic vessel/body (r).

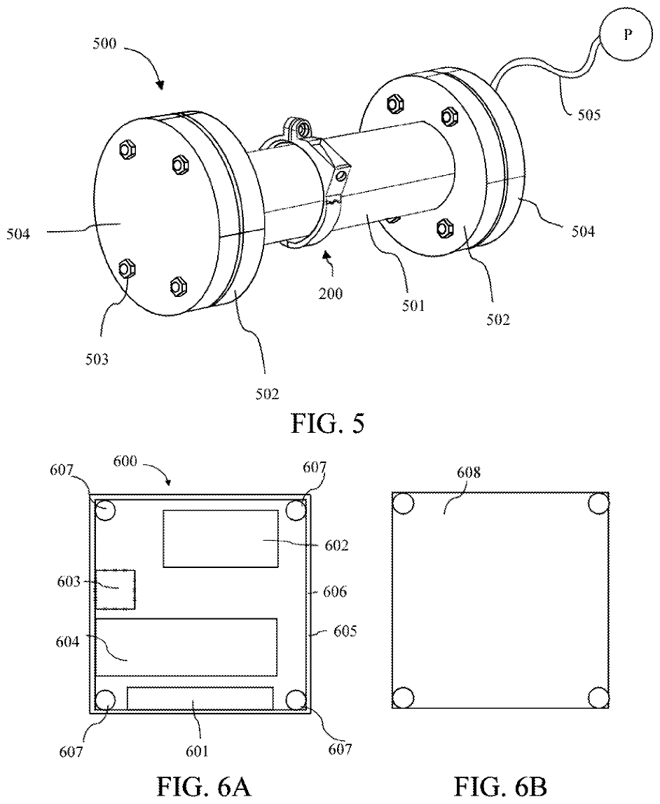

The calibration rig (500) part of the system is utilized to calibrate and ensure correct resistance and accuracy of printed strain gauges (400) and distributed strain sensors (100)/(400) (100). An embodiment of the calibration rig (500) is illustrated in FIG. 5. The calibration rig (500) for the PVDF sensor (100) consists of a Schedule 40 steel pipe (501) which acts as the surface of an elastic vessel (r) with standard flanges (502) welded to each end as shown. Each end flange bolts (503) to a flat endcap (504). An actuator and hydrophone are installed via drilling and tapping the pipe (501). Inlet and outlet holes are also drilled and tapped. Tubing (505) and a pump (P) are provided to generate a known pressure. The completed calibration rig (500) is then connected to the PVDF wire/strip (101) sensor (100)/(400) which is connected to the sensor/power conditioning module (600). A printed strain gauge (401) may also be attached to the completed calibration rig (500) as needed for calibration. Calibration of the printed strain gauge (401) occurs via a commercially available Wheatstone bridge/amplifier. The calibration rig (500) has an elastic pressurized tube (r) acting as the elastic vessel (r) for calibrating a distributed sensor (100)/(400) or a plurality of distributed sensors (100)/(400), an internal pressure exciter to provide static and dynamic pressure or tubing (505) connected to a pump (P) to provide static and dynamic pressure, and one or more standard pressure sensors to provide a reference pressure value.

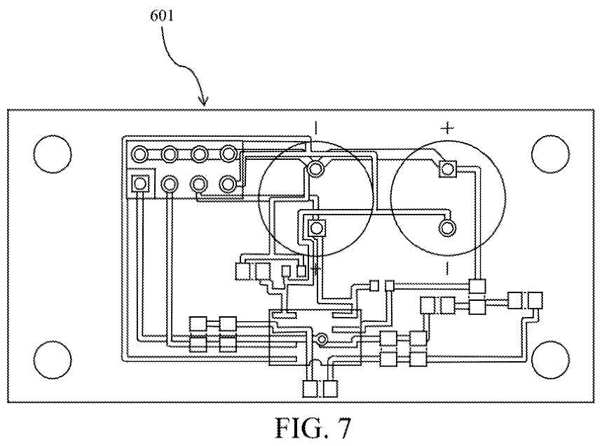

The Wheatstone bridge/amplifier to monitor the string gauge(s) and a hydrophone are both attached to the calibration rig (500) for monitoring any installed sensor(s) (100) or (400). To determine system sensitivity, a wire sensor (100) is applied to the calibration rig (500) and subjected to standard excitation pressure signal. The output is then compared to the established reference values for the calibration rig (500) and the difference is used to determine the specific sensor's sensitivity. FIGS. 6A and 6B are an embodiment of the sensor power/conditioning module (600). This is a critical component of the system, specifically the charge amplifier circuitry (601). The sensor power/conditioning module (600) contains several items.

The miniaturized circuit board (601) for the sensor power/conditioning module (600) provides signal conditioning for four separate PVDF sensors (100) and is a miniaturized signal conditioning pre-amplifier. FIG. 7 is an embodiment of the printed circuit (601) of the control module (600). The approximate size of the control board (601) is 1″×2″ and is populated with low-noise components, filtering, and input/output headers. FIG. 6A also includes the power supply (602), sensor BNC terminator (603), and a Raspberry Pi Wi-Fi/cellular board (or similar) (604), contained in a single case (605). Power is provided using either two standard 1.5V “AAA” alkaline batteries or other compact batteries, direct A/C power, or via a solar panel attached to a rechargeable battery unit.

The smallest enclosure case (605) for a single channel is approximately 3″×3″×2″, contained in a weatherproof ruggedized die-cast aluminum case (607). A rubber seal (606), where the lid (608), shown in FIG. 6B, is attached to the case using screws (607) on the four corners of the case (605), is used for sealing. The enclosure itself is environmentally sealed, although the switches and connectors used are not environmentally sealed. Weather-proofing connectors and switches are an alternative construction. Depending on number of channels beyond one being measured, the weatherproof ruggedized die-cast aluminum case is sized accordingly.

For the electronics and sensor packaging, a single-channel fixed gain design has been created. The gain can be changed but is not intended to be a field adjustable value. Rather, the nominal gain tables derived during design will be used to provide a calibrated output. The circuit board, circuits, power supply, and connecters are installed in a metal box that is in line with the triaxial lead coming from the sensor wire/strip (101). The sensor wire/strip (101) is terminated in a standard BNC connector. An indicator light shows when the unit is powered on, and the battery pack is easily accessible through removal of four Philips head screws (607) for example which are located on the top of the case (605). The complete system (12) can be calibrated with the calibration rig (500).

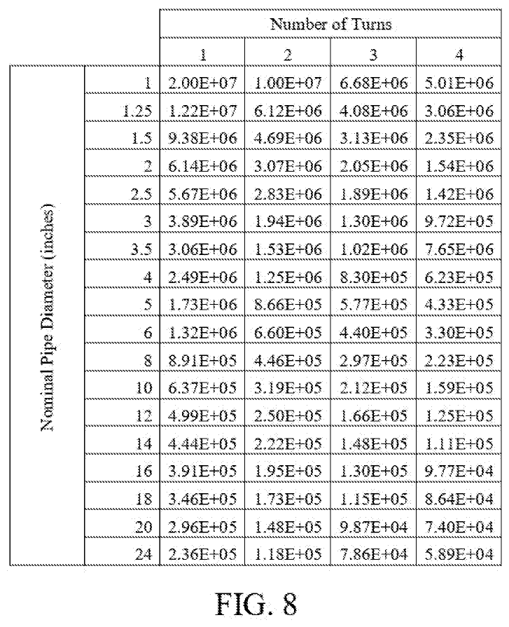

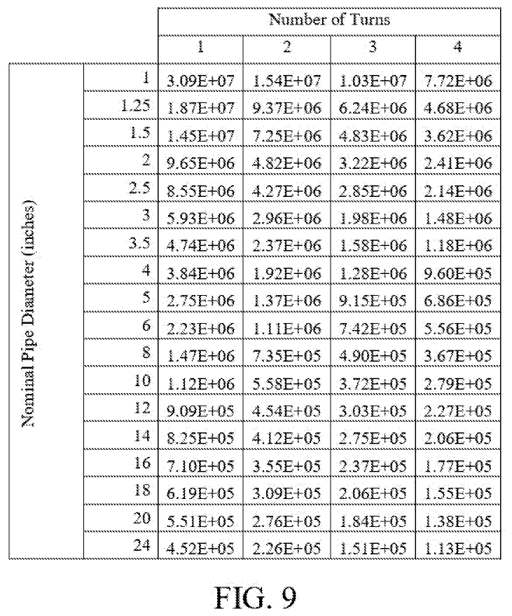

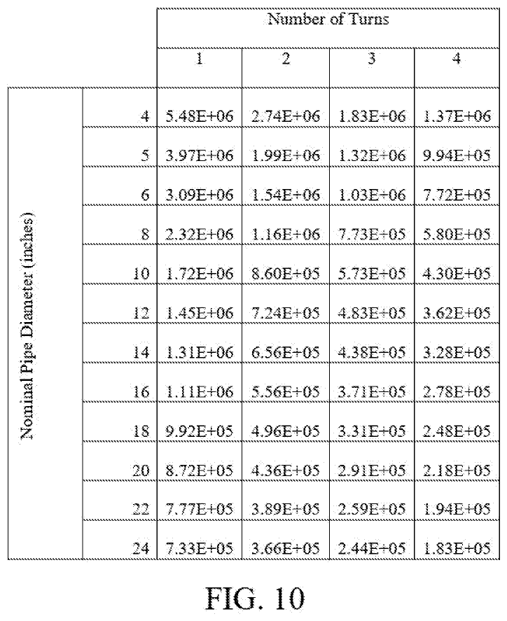

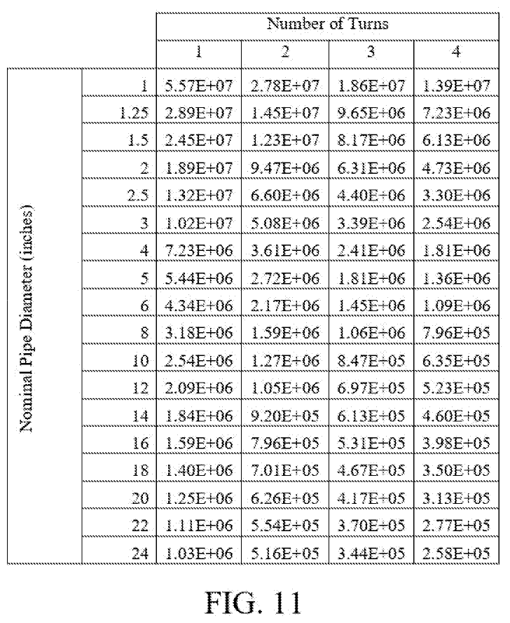

Nominal sensitivity of PVDF sensors (100) on standard schedule 40 Steel pipe sizes, based on number of turns of the sensor wire (101) around the pipe (r) using the clamp (200) as an installation tool, are represented in FIG. 8. These sensitivity values are [Pa/V]. Similar tables for Schedule 80 Steel, Schedule 120 Steel and Schedule 160 Steel are also reflected in FIGS. 9, 10, and 11 respectively.

A mobile/tablet software application is also presented for visualization of data captured by either the Wheatstone Bridge/Amplifier for the printed strain gauge (400), or strain gauge wire (102), or the sensor power/conditioning module (600) for PVDF sensors (100) and (400). The application includes both a cloud-based server component as well as a client application for end user use.

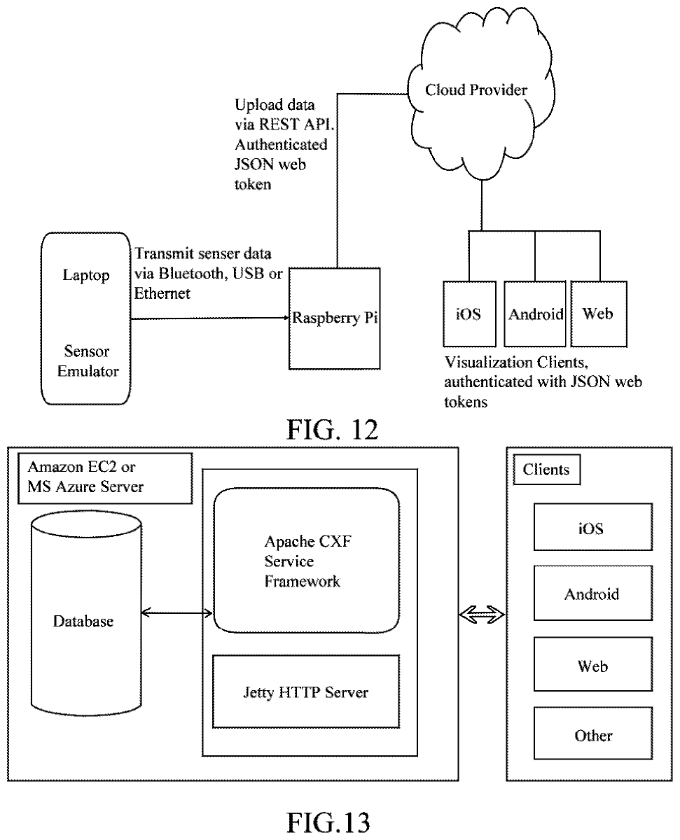

An example of the server side has an application which operates on cloud service and interfaces with any client with internet connectivity for access to exposed RESTful services including sensors (100)/(400), mobile, and web applications. The client application as an example operates on both Android® and Apple iOS® operating systems and is also supported via web browsers including, but not limited to, Internet Explorer®, Mozilla Firefox®, and Google Chrome®. Clients access a cloud provider where measured and captured pressure data is stored. Users are authenticated with JSON web tokens for example. An overview of this architecture is represented in FIG. 12.

Pressure measurements taken by the sensors (100)/(400) are captured by the power/conditioning module (600) for PVDF sensors (100) or via the Wheatstone Bridge/Amplifier for printed strain gauges (400). The data measurements are then passed to a commercially available “miniaturized computer” such as for example a Raspberry Pi with Wi-Fi and/or cellular service functionality which serves as a wireless data transmission device. This sending unit is either directly connected or integrated to the power/conditioning module (600), or physically connected to the Wheatstone Bridge/Amplifier.

Using either the Wi-Fi or cellular connectivity, the Raspberry Pi uploads the pressure measurement data captured to the cloud provider via REST API with an authenticated JSON web token. The data is analyzed using quantitative predictive modeling techniques, and processed with full visualization support including performance summaries, time-histories, alerts, and notifications across all mobile device platforms. When an array of sensors (that is more than one sensor (100) axially located on the elastic body) are used, the signals from the individual sensor (100) in the array are acquired, sent to the cloud or a local processor in which software is implemented to process the individual signals to also measure flow rate, corrosion of the elastic containing body, bubbles in the fluid and inhomogeneity of the fluid.

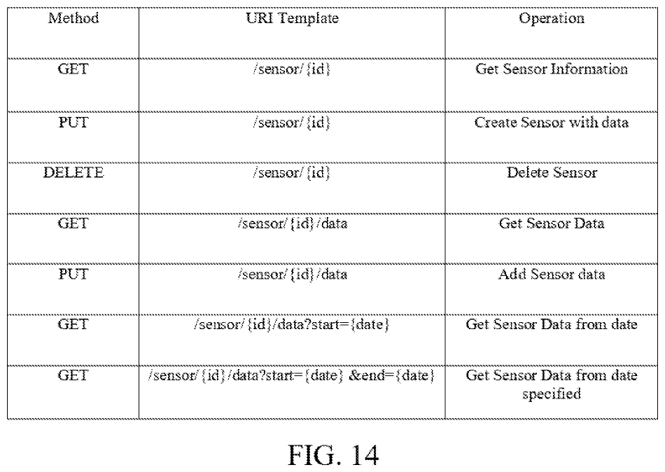

The cloud service for pressure data storage includes a database, Apache CXF service framework, and a Jetty HTTP server visually supported by FIG. 13. Connectivity to clients is provided via standards based RESTful web services. Successful authentication of a client user to their data exposes specified data. Data connectivity between client and cloud service is bi-directional. Interconnect between the client and server for the application has multiple methods and operations. A summary table of these methods and operations for the restful API are reflected in FIG. 14.

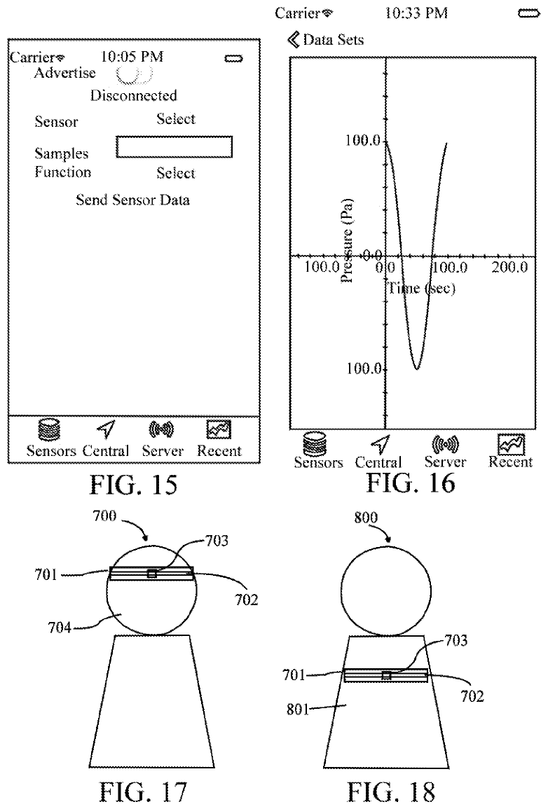

The client application is launched by the user on the device they are using to retrieve sensor data. The user then authenticates to the cloud server as a unique and authorized user using a unique user identification (ID) and password combination. Once connected, the user selects the option of Advertise on the application home screen which can be seen in FIG. 15. This begins scanning for sensors (100) and (400) and returns a list of sensors associated with the user's account. This list includes the name and unique user ID for the sensor. Once connected, the user specifics sample rate, sends RESET signal and gets sample rate of the sensor (100)/(400). The sensor (100)/(400) will return an “ok” response and the application begins accepting data for the selected sensor(s). Data is provided to the application in the form of Y-Value where Y is the pressure measurement and X-Value where X is the sample rate as previously entered by the user. Data is provided in a graph format reflecting measured pressures over time selected. An example of this data can be seen in FIG. 16. Users may select data points to save as desired.

An example application of the PVDF sensor (702) can be seen in FIG. 17 for human head pressure readings and FIG. 18 for a human chest pressure reading. As shown, the sensor (702) is attached to either the human head (704), or the human chest (801) using a flexible band (701). In both instances, a connector (703) is utilized for pressure readings from the sensor (702). This in turn mates to the power conditioning module (600) for reading and output of pressures. Wireless transfers of sensor signals are also used.

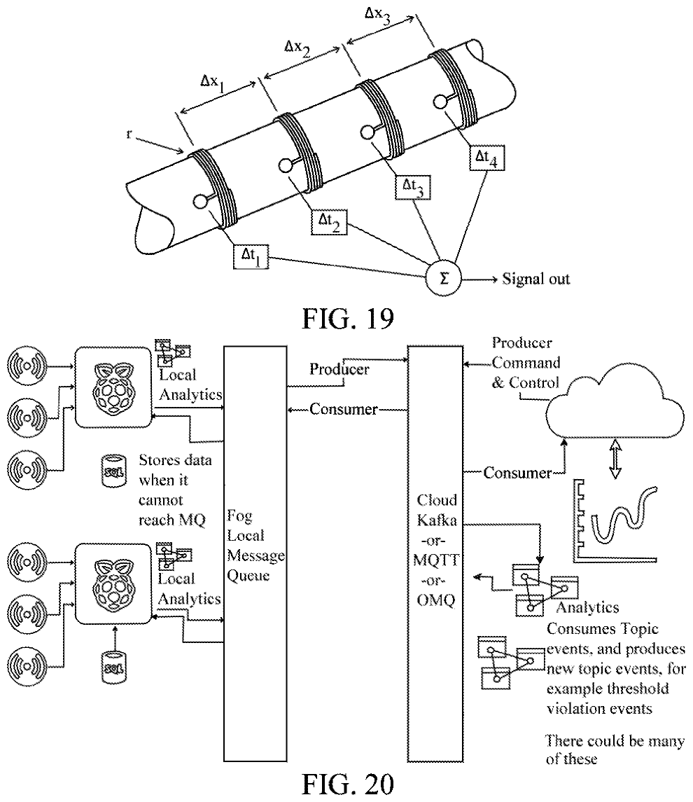

Another example involves the use of an array of sensors (100) and/or (400) to non-invasively monitor the health of pipelines. FIG. 19 shows a PVDF sensor array attached to a pipeline. The sensors (100) and/or (400) are externally mounted on existing or new pipes and their signals are processed to measure the dynamic pressure, the fluid flow rate, and to monitor pump and valve health. The sensor array (100)/(400) according to the present invention can be used to monitor for interior corrosion and leak detection, pump and bearing failure, card taken, slug flow which helps avoid unplanned outages and increases productivity. By detecting the slightest anomaly in pressure changes in pipes due to corrosion, leaks, and unhealthy pumps, failures can be avoided. In operation, an oil rig that has 30,000 sensors has only one percent of the data examined to detect and control anomalies. The present invention monitors all of the data collected using artificial intelligence to optimize and predict operations. FIG. 20 is an object diagram reflecting a monitoring of the software data flow generated by the signals generated by the array. These signals are captured and analyzed, and wherever a problem arises the specific sensor, n, which generated the signal in question is known and any problem monitored by that sensor can more quickly be identified for remedial action.

It is to be understood that the present invention is not limited to the embodiments described above, but encompasses any and all embodiments within the scope of the following claims.

What is claimed is:

1. A distributed strain sensor (100)/(400) system (12) for measuring strain over a significant dimension fraction length or area of a surface of an elastic pressure vessel (r), the distributed strain sensor (100)/(400) system (12) comprising:
a strain sensor (100)/(400), or multiple strain sensors (100)/(400), each having continuous, segmented flexible or nonflexible piezoelectric material (PVDF); or
a strain sensor (100)/(400), or multiple strain sensors (100)/(400), each having continuous, segmented flexible or nonflexible strain gauge material; and
wherein each strain sensor (100)/(400) is composed of a flat ribbon (401),
cylindrical wire (101) or combinations thereof.

2. The distributed strain sensor (100)/(400) system (12) of claim 1, wherein:
each strain sensor (100)/(400) is
attached to the exterior of the elastic pressure vessel (r); or
clamped to the exterior of the elastic pressure vessel (r) by a clamp (200).

3. The distributed strain sensor (100)/(400) system (12) of claim 1, wherein:
each strain sensor (100)/(400) is attached to the surface of the elastic pressure vessel (r), and is either glued or fixed with adhesive tape; or
each strain sensor (100)/(400) is wrapped a complete or partial number of turns around the elastic pressure vessel (r); or
combinations thereof.

4. The distributed strain sensor (100)/(400) system (12) of claim 1, wherein:
each strain sensor (100)/(400) is combined with multiple strain sensors (100)/(400) forming an array or multiple arrays of individual strain sensors (100)/(400) arranged axially, tangentially, or at an angle along a dimension of the surface of the elastic pressure vessel (r).

5. The distributed strain sensor (100)/(400) system (12) of claim 1, wherein:
each strain sensor (100)/(400) further has EMF shielding (102), and/or
electronic connections and circuitry to implement the EMF and electrical noise shielding at (600).

6. The distributed strain sensor (100)/(400) system (12) of claim 1, further comprising:
electronics (601) to convert the piezoelectric charge output into amplified proportional voltage; or
electronics (601) to convert each sensor strain output into proportional voltage; or
combinations thereof.

7. The distributed strain sensor (100)/(400) system (12) of claim 1, further comprising:
a clamp (200) to accommodate each sensor (100)/(400) or an array of clamps (200) to accommodate each sensor (100)/(400) in an array of multiple sensors (100)/(400);
wherein each clamp (200)
holds each sensor (100)/(400) against the surface of the elastic pressure vessel (r),
includes sensor electronics (601),
is made from stiff materials,
has four segments (201), (202), (203) and (205), or
is spring loaded at (300) to create different diameters to accommodate differences dimensions along the surface of the elastic pressure vessel (r), or
combinations thereof.

8. The distributed strain sensor (100)/(400) system (12) of claim 7, wherein:
the PVDF wire/strip (101) is disposed on the clamp (200) to facilitate contact with the surface of the elastic pressure vessel (r);
the PVDF wire/strip (101) is fed through, and disposed within, a threaded groove (211) or a groove (211) designed to accommodate the PVDF wire/strip (101).

9. The distributed strain sensor (100)/(400) system (12) of claim 1, further comprising:
a calibration rig (500) for calibrating each sensor (100)/(400) either individually or as an array of sensors (100)/(400), the calibration rig (500) having a surface of an elastic pressure vessel (r) with known pressures differences.

10. The distributed strain sensor (100)/(400) system (12) of claim 1, further comprising:
software to convert
each sensor output voltage into pressure units; or
multiple sensor output into flow rate; or
multiple sensor output into fault detection of leaks, pump failure and valve failure; or
each sensor or multiple sensor output into corrosion detection; or
multiple sensor outputs into slug flow detection and measurement of acoustic wave speed and pipe wall thickness; or
combinations thereof; and
artificial intelligence combined with machine learning for predictive modeling and detection of pipe failure modes including over pressure, under pressure, fault detection of leaks, pump failure, valve failure, corrosion buildup, or combinations thereof.

11. A clamp (200) for clamping a distributed sensor (100)/(400) to a surface of an elastic pressure vessel (r), comprising:
sensor (100)/(400) clamp (200)
for clamping the distributed sensor (100)/(104) to an elastic pressure vessel (r),
which completely encircles the pressure vessel (r), and maintains pressure on the distributed sensor (100)/(400) to clamp it to the elastic pressure vessel (r).

12. The clamp (200) for clamping a distributed sensor (100)/(400) to the elastic pressure vessel (r) of claim 11, further comprising:
a spring and latch at (300) to apply pressure to the sensor (100)/(400).

13. The clamp (200) for clamping a distributed sensor (100)/(400) to the elastic pressure vessel (r) of claim 11, further comprising:
a feed hole (213) and groove (211) for locating the sensor (100)/(400).

14. The clamp (200) for clamping a distributed sensor (100)/(400) to the elastic pressure vessel (r) of claim 11, further comprising:
a connection terminal at (301), power electronics (600), and a voltage output terminal at (301) for the sensor (100)/(400).

15. The clamp (200) for clamping a distributed sensor (100)/(400) to the elastic pressure vessel (r) of claim 11, wherein:
the clamp (200) is constructed from polymer, metals, or composite material; or
the clamp (200) is constructed by 3D printing; or
combinations thereof.

16. The clamp (200) for clamping a distributed sensor (100)/(400) to the elastic pressure vessel (r) of claim 11, comprising:
battery power, lines main power or solar power of the sensor (100)/(400) electronics (600);
a wireless system to transmit the sensor signal for storage and data processing in the cloud; or
combinations thereof.

17. A calibration rig (500), comprising:
an elastic pressurized tube (r) for calibrating a distributed sensor (100)/(400) or a plurality of distributed sensors (100)/(400).

18. The calibration rig (500) of claim 17, further comprising:
an internal pressure exciter to provide static and dynamic pressure.

19. The calibration rig (500) of claim 17, further comprising:
one or more standard pressure sensors to provide a reference pressure value.

20. The calibration rig (500) of claim 17, further comprising:
tubing (505) connected to a pump (P) to provide static and dynamic pressure.
